(19) United States
(12) Patent Application Publication
(10) Pub. No.: US 2025/0277475 A1
(43) Pub. Date: Sep. 4, 2025

(54) Aircraft Thrust Reverser Corrosion Shield

(71) Applicant: Textron Aviation Inc., Wichita, KS (US)

(72) Inventors: Travis Elliot Smith, Wichita, KS (US); Israel Antonio Hernandez, Wichita, KS (US)

(21) Appl. No.: 18/594,479

(22) Filed: Mar. 4, 2024

(51) Int. Cl. F02K 1/00

(52) U.S. Cl. CPC F02K 1/002; F05D 2260/95; F05D 2300/121

(57) ABSTRACT

A corrosion shield for an aircraft thrust reverser includes pivot door skins and side beam skins which cover the pivot doors and side beams of an aircraft thrust reverser. The pivot door skins and side beam skins may be secured using fasteners already included with the aircraft thrust reverser. The pivot door skins and the side beam skins are configured to protect surfaces of the aircraft thrust reverser from exhaust produced by an aircraft engine.

### BACKGROUND OF THE INVENTION

### 1. Field

The disclosed embodiments relate generally to the field of aircraft thrust reversers. More specifically, the disclosed embodiments relate to the field of corrosion prevention on aircraft thrust reversers.

### 2. Description of the Related Art

Aircraft thrust reverser systems are known. For instance, U.S. Pat. No. 7,043,897 to Osman discloses a thrust reverser system having rectangular doors to optimize thrust reversal.

It is also known to form a thrust reverser system having a device for collecting cool air to cool the thrust reverser system. For instance, U.S. Pat. No. 10,605,196 to Caruel et al. discloses a device which collects cool air to cool the thrust reverser system and reduces the amount of Aluminum 2219 needed in the system.

It is also known to form a thrust reverser system from corrosion resistant materials. For instance, U.S. Patent Application Publication No. 2013/0009004 to Do discloses a thrust reverser system having components fabricated from a corrosion resistant material.

### SUMMARY

This summary is provided to introduce a selection of concepts in a simplified form that are further described below in the detailed description. This summary is not intended to identify key features or essential features of the claimed subject matter, nor is it intended to be used to limit the scope of the claimed subject matter. Other aspects and advantages will be apparent from the following detailed description of the embodiments and the accompanying drawing figures.

In embodiments, an aircraft thrust reverser corrosion shield includes: a pivot door skin configured for mounting to a pivot door of an aircraft thrust reverser thereby protecting the pivot door from an exhaust of an aircraft engine; and a side beam skin configured for mounting to a side beam of the aircraft thrust reverser thereby protecting the side beam from the exhaust of the aircraft engine.

In some embodiments, an aircraft thrust reverser corrosion shield includes: a first pivot door skin configured for mounting to an inner surface of a first pivot door of an aircraft thrust reverser; a second pivot door skin configured for mounting to the inner surface of a second pivot door of the aircraft thrust reverser; a first side beam skin configured for mounting to the inner surface of a first side beam of the aircraft thrust reverser; and a second side beam skin configured for mounting to the inner surface of a second side beam of the aircraft thrust reverser, wherein the first and second pivot door skins and the first and second side beam skins each include an exhaust surface configured to face towards an exhaust nozzle of an aircraft engine.

### BRIEF DESCRIPTION OF THE SEVERAL VIEWS OF THE DRAWINGS

Illustrative embodiments are described in detail below with reference to the attached drawing figures, which are incorporated by reference herein and wherein:

FIG. 1A is a perspective view of an aircraft thrust reverser installed onto an aircraft with thrust reverser doors closed;

FIG. 1B is a perspective view of the aircraft thrust reverser of FIG. 1A with thrust reverser doors opened;

FIG. 2A is a perspective view of a pivot door of the aircraft thrust reverser of FIG. 1A;

FIG. 2B is a perspective view of a side beam of the aircraft thrust reverser of FIG. 1A;

FIG. 2C is a perspective view of the side beam and pivot door fastened to the aircraft thrust reverser of FIG. 1A;

FIG. 3 is a perspective view of a corrosion shield configured for use with the aircraft thrust reverser of FIG. 1A; and

FIG. 4 is a front view of the corrosion shield of FIG. 3 installed onto the aircraft thrust reverser of FIG. 1A.

The drawing figures do not limit the invention to the specific embodiments disclosed and described herein. The drawings are not necessarily to scale, emphasis instead being placed upon clearly illustrating the principles of the invention.

### DETAILED DESCRIPTION

The following detailed description references the accompanying drawings that illustrate specific embodiments in which the invention can be practiced. The embodiments are intended to describe aspects of the invention in sufficient detail to enable those skilled in the art to practice the invention. Other embodiments can be utilized and changes can be made without departing from the scope of the invention. The following detailed description is, therefore, not to be taken in a limiting sense. The scope of the invention is defined only by the appended claims, along with the full scope of equivalents to which such claims are entitled.

In this description, references to “one embodiment,” “an embodiment,” or “embodiments” mean that the feature or features being referred to are included in at least one embodiment of the technology. Separate references to “one embodiment,” “an embodiment,” or “embodiments” in this description do not necessarily refer to the same embodiment and are also not mutually exclusive unless so stated and/or except as will be readily apparent to those skilled in the art from the description. For example, a feature, structure, act, etc. described in one embodiment may also be included in other embodiments, but is not necessarily included. Thus, the technology can include a variety of combinations and/or integrations of the embodiments described herein.

Aircraft thrust reversers are positioned aft of an aircraft jet engine and provide an exhaust path for exhaust produced by the engine. Exhaust produced from an aircraft engine includes combustion byproducts that typically contain particle matter and is expelled at high temperatures which may corrode the surfaces of the aircraft thrust reversers exposed to the engine exhaust. In current arrangements, aircraft thrust reversers may be fabricated from aluminum and corrosion may be mitigated by applying a paint layer over the aluminum surface of the thrust reverser. The applied paint layer is often limited in its ability to withstand high temperatures and is therefore often not substantially effective in preventing corrosion to an aircraft thrust reverser.

Embodiments disclosed herein provide a corrosion shield for an aircraft thrust reverser. The corrosion shield for an aircraft thrust reverser includes a skin formed from an aluminum alloy which fastens onto the surface of the aircraft thrust reverser. The corrosion shield may be fastened using existing fasteners on the thrust reverser and may be adhered to the doors and side beams of the thrust reverser using an adhesive such that the corrosion shield is supported by the underlying structure of the thrust reverser. The corrosion shield is replaceable if the shield becomes damaged.

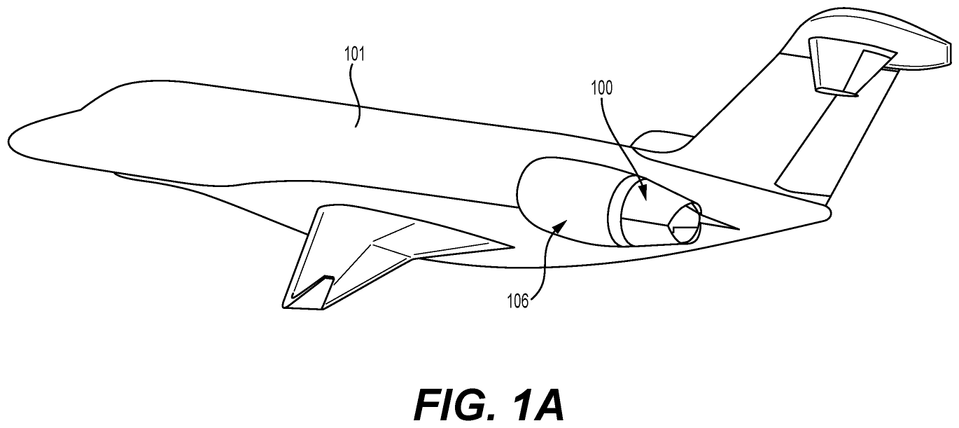

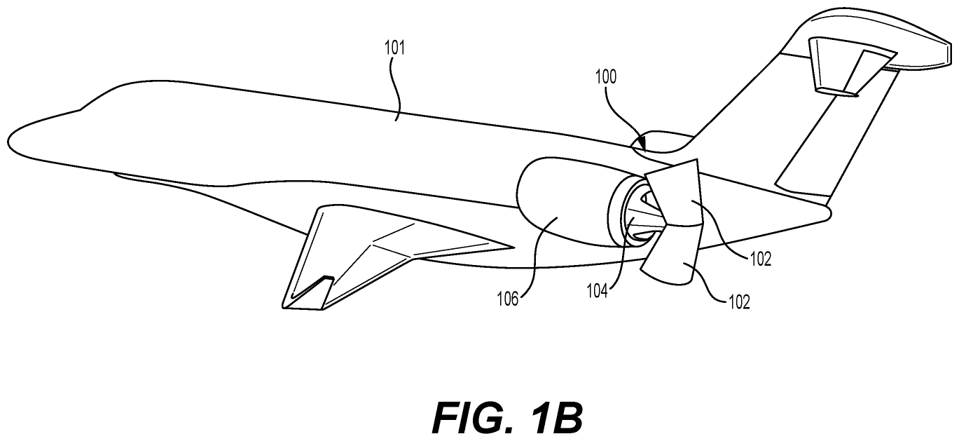

FIG. 1A shows a perspective view of an aircraft thrust reverser 100 installed onto an aircraft 101. The aircraft thrust reverser 100 has a circular or nearly circular exit and is positioned aft of the aircraft engine 106 such that exhaust expelled from an exit nozzle of the aircraft engine 106 is expelled through the thrust reverser 100. In FIG. 1A the aircraft thrust reverser 100 has its doors closed while in FIG. 1B the doors of the aircraft thrust reverser 100 are open.

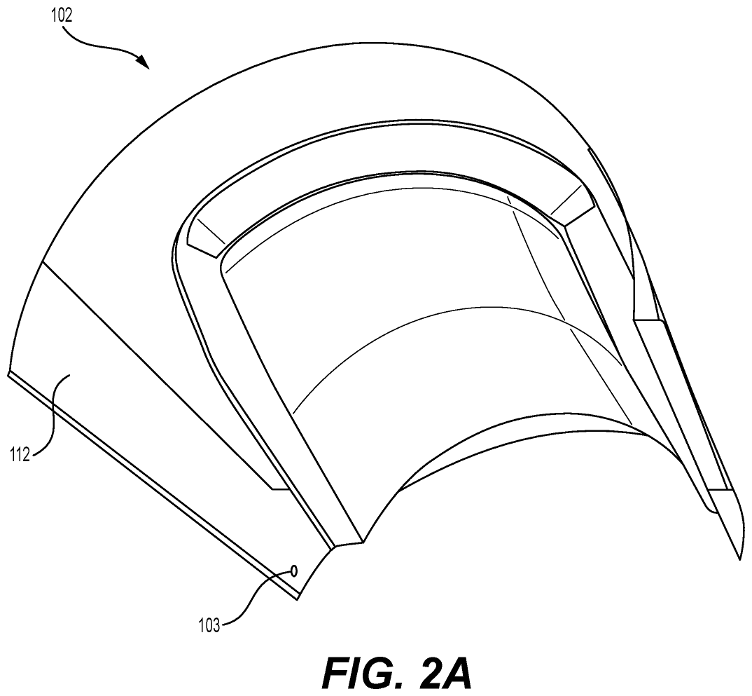

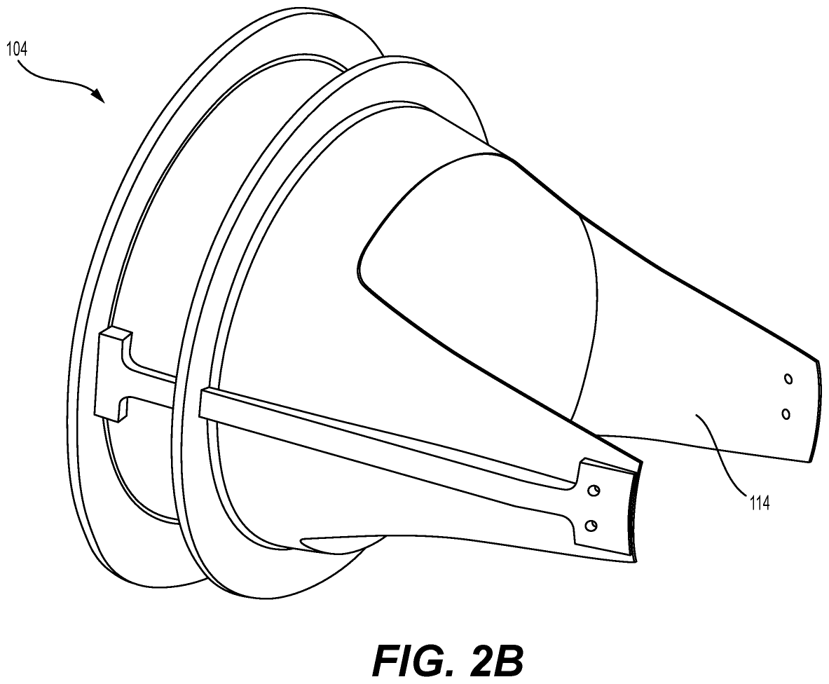

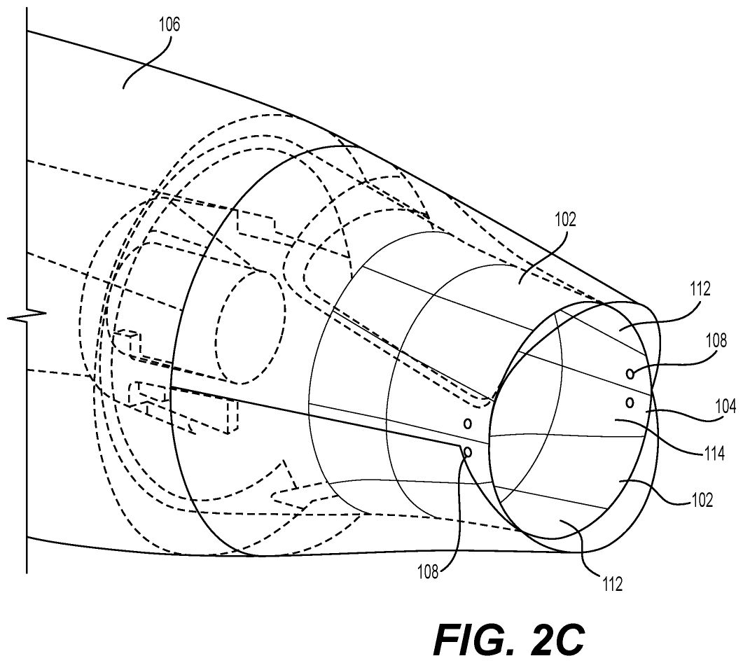

FIG. 2A shows a pivot door 102. The pivot door 102 is curved and gradually narrows from one end to the other to match the inner curvature of the aircraft thrust reverser 100. The pivot door 102 may include structural holes 103 such that fasteners (e.g., bolts) may be inserted to secure the pivot door 102 to the aircraft thrust reverser 100.

FIG. 2B shows a side beam 104. The side beam 104 is curved to match a portion of the inner curvature of the aircraft thrust reverser 100. In embodiments, the side beam 104 includes outcropped portions and voids which may be strategically positioned to align with existing aircraft structure or fasteners of the thrust reverser 100.

FIG. 2C shows pivot doors 102 and side beams 104 installed onto the aircraft thrust reverser 100. In FIG. 2C, portions of the outer surfaces are depicted transparent for viewing underlying components. The curvature of the pivot doors 102 is substantially matched with the curvature of the aircraft thrust reverser 100 such that the pivot doors 102 when installed are substantially flush with an inner surface of the thrust reverser 100. The pivot doors 102 may be positioned on upper and lower regions of the circular thrust reverser 100. The side beams 104 are disposed on opposite sides of the aircraft thrust reverser 100 and in between the opposing pivot doors 102. The curvature of the side beams 104 is also configured such that the side beams 104 are substantially flush with an inner surface of the thrust reverser 100 when installed. The aircraft thrust reverser 100 includes access panels or fasteners 108 which secure the pivot doors 102 and the side beams 104 which form the outer structure of the aircraft thrust reverser 100. In embodiments, the fasteners 108 extend through the pivot doors 102 on either side of the side beams 104. The pivot doors 102 include an exhaust surface 112 which is the surface exposed to the exhaust expelled by the engine 106. The side beams 104 include an exhaust surface 114 which is the surface exposed to the exhaust expelled from the engine 106. In some embodiments, the exhaust surfaces 112 and 114 may be coated with a paint having properties to slow/prevent corrosion. In some embodiments, the pivot doors 102 and/or the side beams 104 may include hinges or other pivotable mechanisms to allow the pivot doors 102 to pivot towards one another, decreasing the diameter of the aircraft thrust reverser 100 and redirecting a portion of the exhaust being expelled from the engine 106 (see FIG. 1B). In embodiments, the pivot doors 102 and side beams 104 may be fabricated from an Aluminum alloy (e.g., Aluminum alloy 2219). The Aluminum alloy may be susceptible to corrosion when exhaust is expelled from the engine 106 and through the aircraft thrust reverser 100.

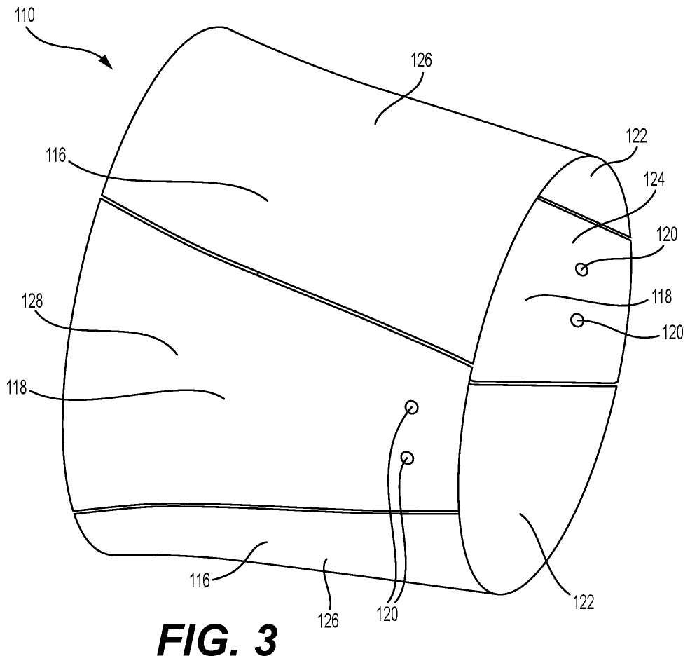

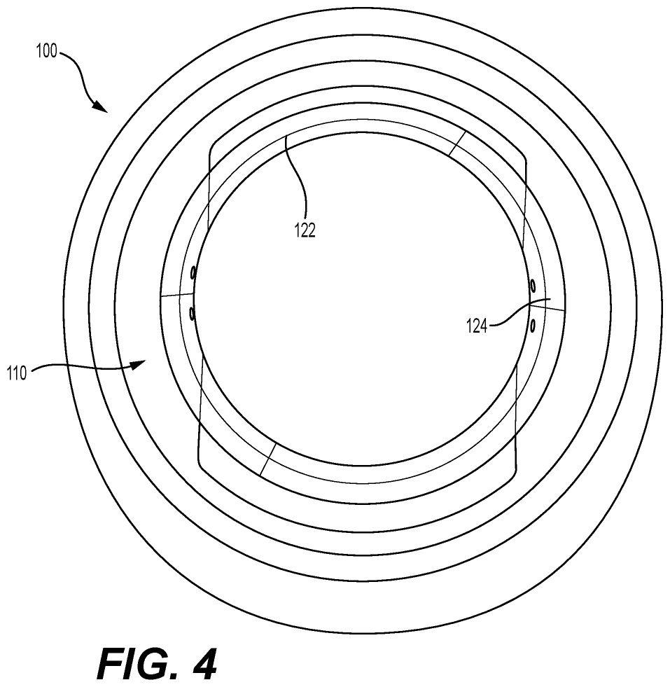

FIG. 3 shows a perspective view of a corrosion shield 110. In embodiments, the corrosion shield 110 includes pivot door skins 116 and side beam skins 118. The pivot door skins 116 include an exhaust surface 122 and the side beam skins 118 include an exhaust surface 124 which are the inner facing surfaces of the corrosion shield 110 which face towards the center of the aircraft thrust reverser 100. The pivot door skins 116 include a thrust reverser facing surface 126 and the side beam skins 118 include a thrust reverser facing surface 128 which are the outer facing surfaces of the corrosion shield 110. The pivot door skins 116 are shaped to fit directly onto the exhaust surface 112 of the pivot doors 102 and the side beam skins 118 are shaped to be placed directly onto the exhaust surface 114 of the side beams 104 such that the thrust reverser facing surface 126 of the pivot door skins 116 directly contacts and is substantially flush with the exhaust surface 112 of the pivot doors 102, and the thrust reverser facing surface 128 of the side beam skins 118 directly contacts and is substantially flush with the exhaust surface 114 of the side beams 104 (see FIG. 4). The pivot door skins 116 include fastener holes 120 through the skin for the hinges. In some embodiments, the fastener holes 120 may have an irregular shape and are located such that the fasteners 108 of the pivot doors 102 may be used to secure the pivot door skins 116 to the pivot doors 102. In other embodiments, the fastener holes 120 may be located on the side beam skins 118 or at other locations on the pivot door skins 116 such that fasteners 108 which secure the pivot doors 102 and side beams 104 to the aircraft thrust reverser 100 may be utilized to secure the pivot door skins 116 and side beam skins 118. In some embodiments, dedicated fasteners may be added for securing the pivot door skins 116 and side beam skins 118 to the pivot doors 102 and side beams 104. In some embodiments, a heat-resistant adhesive may be applied in addition to or in the place of fasteners to the exhaust surfaces 112 and 114 such that the pivot door skins 116 and side beam skins 118 may be adhered to the pivot doors 102 and side beams 104. As best seen in FIG. 4, the securement of the corrosion shield 110 directly onto the pivot doors 102 and side beams 104 substantially covers the exhaust surface 112 of the pivot doors 102 and exhaust surface 114 of the side beams 104 such that exhaust expelled from the engine 106 is directed onto the exhaust surface 122 and exhaust surface 124 of the pivot door skins 116 and side beam skins 118, respectively, rather than the exhaust being directed onto the exhaust surfaces 112, 114 of the thrust reverser 100.

Advantageously, the pivot door skins 116 and side beam skins 118 of the corrosion shield 110 provide coverage and shielding of the exhaust surface 112 of the pivot doors 102 and exhaust surface 114 of the side beams 104 from expelled exhaust, which substantially reduces or prevents corrosion from occurring on the pivot doors 102 and side beams 104 of the thrust reverser 100. In some embodiments, the corrosion shield 110 is fabricated from the Aluminum alloy 6000 and in other embodiments the corrosion shield 110 is fabricated from the Aluminum alloy 5000. The alloys Aluminum 6000 and Aluminum 5000 are each medium strength, corrosion resistant alloys. In other embodiments, other reasonably strong, corrosion resistant alloys could be used. In more specific embodiments, the Aluminum alloys 6061 and 5052 may be used which are both galvanically compatible with the underlying aluminum structure, which in embodiments are the pivot doors 102 and side beams 104. The galvanic compatibility of the Aluminum alloys 6061 and 5052 and the underlying Aluminum structure allows for the contact between the exhaust surface 112 of the pivot doors 102 and the thrust reverser facing surface 126 of the pivot door skins 116, and the contact between the exhaust surface 114 of the side beams 104 and the thrust reverser facing surface 128 of the side beam skins 118, to not corrode each other from direct contact. In embodiments, the weight of the pivot door skins 116 is approximately one pound and in other embodiments the weight of the pivot door skins 116 may be approximately half to two pounds. In embodiments, the weight of the side beam skins 118 is approximately 0.25 pounds and in other embodiments the weight of the side beam skins 118 may be approximately 0.1 to 0.5 pounds. In embodiments, the corrosion shield 110 may be approximately two and a half pounds and in other embodiments the corrosion shield 110 may be approximately one and a half to three and a half pounds. In embodiments, the corrosion shield 110, including the pivot door skins 116 and side beam skins 118, is approximately 0.020 inches thick and in other embodiments the corrosion shield 110 may be 0.010 to 0.040 inches thick. The corrosion shield 110 is configured to last for the lifetime of the thrust reverser 100.

Many different arrangements of the various components depicted, as well as components not shown, are possible without departing from the spirit and scope of what is claimed herein. Embodiments have been described with the intent to be illustrative rather than restrictive. Alternative embodiments will become apparent to those skilled in the art that do not depart from what is disclosed. A skilled artisan may develop alternative means of implementing the aforementioned improvements without departing from what is claimed.

It will be understood that certain features and subcombinations are of utility and may be employed without reference to other features and subcombinations and are contemplated within the scope of the claims. Not all steps listed in the various figures need be carried out in the specific order described.

The claims are amended as follows:

1. An aircraft thrust reverser corrosion shield, comprising:
a pivot door skin configured for mounting to a pivot door of an aircraft thrust reverser thereby protecting the pivot door from an exhaust of an aircraft engine; and
a side beam skin configured for mounting to a side beam of the aircraft thrust reverser thereby protecting the side beam from the exhaust of the aircraft engine,
wherein the pivot door skin and the side beam skin match up against each other, thereby substantially covering the pivot door and the side beam.

2. The corrosion shield of claim 1 wherein the pivot door skin and the side beam skin substantially cover an entire exhaust surface of the pivot door and the side beam, respectively.

3. The corrosion shield of claim 1 comprising a plurality of fasteners, wherein the fasteners are used to fasten the pivot door skin to the pivot door and the side beam skin to the side beam.

4. The corrosion shield of claim 3, wherein the fasteners comprise existing fasteners of the pivot door and the side beam.

5. The corrosion shield of claim 1 wherein the side beam skin and the pivot door skin each include at least one fastener hole, wherein each fastener hole provides access to a fastener.

6. The corrosion shield of claim 1 wherein the pivot door skin and side beam skin are each fabricated from an Aluminum 6000 alloy.

7. The corrosion shield of claim 1 wherein the pivot door skin and side beam skin are each fabricated from an Aluminum 5000 alloy.

8. The corrosion shield of claim 1 wherein the corrosion shield is 0.010 inch to 0.040 inch thick.

9. The corrosion shield of claim 1 wherein the pivot door skin and the side beam skin each comprise an outer surface configured for directly contacting the pivot door and an inner surface configured for exposure to the exhaust of the aircraft engine.

10. A corrosion shield for an aircraft thrust reverser, comprising:
a first pivot door skin configured for mounting to an inner surface of a first pivot door of an aircraft thrust reverser;
a second pivot door skin configured for mounting to an inner surface of a second pivot door of the aircraft thrust reverser;
a first side beam skin configured for mounting to an inner surface of a first side beam of the aircraft thrust reverser; and
a second side beam skin configured for mounting to an inner surface of a second side beam of the aircraft thrust reverser,
wherein the first and second pivot door skins and the first and second side beam skins each comprise an exhaust surface configured to face towards a center of the aircraft thrust reverser of an aircraft engine, and
wherein the first side beam skin abuts directly against a first edge of the first pivot door skin and abuts directly against a first edge of the second pivot door skin, and the second side beam skin abuts directly against a second edge of the first pivot door skin and abuts directly against a second edge of the second pivot door skin.

11. The corrosion shield of claim 10 wherein the first and second pivot door skins cover the pivot doors and the first and second side beam skins cover the side beams, thereby shielding the pivot doors and the side beams, respectively, from aircraft engine exhaust for mitigating corrosion of the pivot doors and the side beams.

12. The corrosion shield of claim 10 wherein the exhaust surface comprises a corrosion resistant material configured to withstand exposure to aircraft engine exhaust.

13. The corrosion shield of claim 12 wherein the corrosion resistant material comprises an Aluminum alloy.

14. The corrosion shield of claim 13 wherein the Aluminum alloy comprises Aluminum alloy 5052.

15. The corrosion shield of claim 13 wherein the Aluminum alloy comprises Aluminum alloy 6061.

16. The corrosion shield of claim 10 wherein the first and second side beam skins and the first and second pivot door skins each comprise a curvature that matches their respective pivot doors and side beams of the aircraft thrust reverser.

17. The corrosion shield of claim 10 wherein the first and second side beam skins and the first and second pivot door skins are each manufactured from an Aluminum alloy, wherein the Aluminum alloy is galvanically compatible between the pivot door skin and the pivot door and is galvanically compatible between the side beam skin and the side beam.
